(19) United States
(12) Patent Application Publication
(10) Pub. No.: US 2019/0359870 A1
(43) Pub. Date: Nov. 28, 2019

(54) COMPOSITION COMPRISING 2,3,3,3-TETRAFLUOROPROPENE

(71) Applicant: Arkema France, Colombes (FR)

(72) Inventor: Wissam RACHED, Chaponost (FR)

(73) Assignee: Arkema France, Colombes (FR)

(21) Appl. No.: 16/477,263

(22) PCT Filed: Jan. 18, 2018
(86) PCT No.: PCT/FR2018/050127

§ 371 Date: Jul. 11, 2019

(30) Foreign Application Priority Data
Jan. 19, 2017 (FR) 1750413

(51) Int. Cl. C09K 5/04; F25B 30/02

(52) U.S. Cl. CPC C09K 5/045; F25B 30/02; C09K 2205/122; C09K 2205/40; C09K 2205/126

(57) ABSTRACT

The present invention relates to a composition comprising 69% to 78% by weight of 2,3,3,3-tetrafluoropropene, 16% to 22% by weight of difluoromethane, and 2 to 9% by weight of propane, relative to the total weight of the composition. The present invention also relates to various uses of said composition, especially in the field of refrigeration, air conditioning or heat pumps.

### FIELD OF THE INVENTION

The present invention relates to a composition comprising 2,3,3,3-tetrafluoropropene, and uses thereof as heat transfer fluids, in particular for refrigeration, air conditioning and heat pumps.

The fluids containing fluorocarbon compounds are widely used in many industrial devices, in particular air conditioning, heat pumps or refrigeration. These devices have in common relying on a thermodynamic cycle comprising the vaporization of the fluid at low pressure (in which the fluid absorbs heat); the compression of the fluid vaporized up to a high pressure; the condensation of the vaporized fluid into a liquid at high pressure (in which the fluid rejects the heat); and the relaxation of the fluid to end the cycle.

The choice of a heat transfer fluid (which can be a pure compound or a mixture of compounds) is governed first by the thermodynamic properties of the fluid, and secondly by extra constraints.

Specifically, according to the fluid's flammability, safety measures of varying constraints must be taken to use this fluid in some applications, or the use of this fluid can even be prohibited in other applications.

Another important criterion is that of the impact of the considered fluid on the environment. Chlorinated compounds (chlorofluorocarbons and hydrochlorofluorocarbons) have the disadvantage of damaging the ozone layer. Therefore, over them, non-chlorinated compounds such as hydrofluorocarbons, fluoroethers and more recently fluoroolefins (or fluoroalkenes) are generally preferred. Fluoroolefins further generally have a short lifetime, and therefore a lower global warming potential (GWP) than the other compounds.

In this regard, documents WO 2004/037913 and WO 2005/105947 teach the use of compositions comprising at least one fluoroalkene having three or four carbon atoms, in particular pentafluoropropene and tetrafluoropropene, as heat transfer fluids.

Documents WO 2007/053697 and WO 2007/126414 disclose mixtures of fluoroolefins and other heat transfer compounds as heat transfer fluids.

However, olefin compounds tend to be more flammable than saturated compounds.

Therefore a real need exists to obtain and use less flammable heat transfer fluids than those of the state of the art, while having a low GWP, preferably below 150.

### DESCRIPTION OF THE INVENTION

The present invention relates to a composition comprising (preferably constituted of) from 69% to 78% by weight of 2,3,3,3-tetrafluoropropene (HFO-1234yf), from 16% to 22% by weight of difluoromethane (HFC-32), and from 2% to 9% by weight of propane, relative to the total weight of the composition.

Preferably, the composition comprises (preferably is constituted of) from 69% to 78% by weight of 2,3,3,3-tetrafluoropropene (HFO-1234yf), from 19% to 22% by weight of difluoromethane (HFC-32), and from 2% to 9% by weight of propane, relative to the total weight of the composition.

Preferably, the composition according to the invention is such that the total sum of the weight contents of 2,3,3,3-tetrafluoropropene (HFO-1234yf), difluoromethane (HFC-32) and propane equals 100%.

Preferably, the weight content of propane in the composition is comprised for example between 2% and 9%, 2.1% and 9%, 3% and 9%, 4% and 9%, 5% and 9%, 6% and 9%, 7% and 9%, 8% and 9%, 3% and 8%, 4% and 8%, 5% and 8%, 6% and 8%, 7% and 8%, 3% and 7%, 4% and 7%, 5% and 7%, or between 6% and 7%.

Preferably, the weight content of propane in the composition is comprised between 6% and 9%, and advantageously between 6% and 8%.

According to one embodiment, the composition comprises a weight content of propane greater than or equal to 2%, preferably greater than 2%.

According to one embodiment, the composition comprises a weight content of propane greater than or equal to 3%.

According to one embodiment, the composition comprises a weight content of propane greater than or equal to 4%.

According to one embodiment, the composition comprises a weight content of propane greater than or equal to 5%.

According to one embodiment, the composition according to the invention does not comprise between 2% and 5% by weight of propane.

Preferably, the weight content of 2,3,3,3-tetrafluoropropene in the composition according to the invention is comprised for example between 69% and 77.5%, 69% and 77%, 69% and 76.5%, 69% and 76%, 69% and 75.5%, 69% and 75%, 69% and 74.5%, 69% and 74%, 69% and 73.5%, 69% and 73%, 69% and 72.5%, 69% and 72%, 69% and 71.5%, 69% and 71%, 69% and 70.5%, 69% and 70%, 69.5% and 78%, 69.5% and 77.5%, 69.5% and 77%, 69.5% and 76.5%, 69.5% and 76%, 69.5% and 75.5%, 69.5% and 75%, 69.5% and 74.5%, 69.5% and 74%, 69.5% and 73.5%, 69.5% and 73%, 69.5% and 72.5%, 69.5% and 72%, 69.5% and 71.5%, 69.5% and 71%, 69.5% and 70.5%, 70% and 78%, 70% and 77.5%, 70% and 77%, 70% and 76.5%, 70% and 76%, 70% and 75.5%, 70% and 75%, 70% and 74.5%, 70% and 74%, 70% and 73.5%, 70% and 73%, 70% and 72.5%, 70% and 72%, 70% and 71.5%, 70% and 71%, 70.5% and 78%, 70.5% and 77%, 70.5% and 77.5%, 70.5% and 77%, 70.5% and 76.5%, 70.5% and 76%, 70.5% and 75.5%, 70.5% and 75%, 70.5% and 74.5%, 70.5% and 74%, 70.5% and 73.5%, 70.5% and 73%, 70.5% and 72.5%, 70.5% and 72%, 70.5% and 71.5%, 71% and 78%, 71% and 77.5%, 71% and 77%, 71% and 76.5%, 71% and 76%, 71% and 75.5%, 71% and 75%, 71% and 74.5%, 71% and 74%, 71% and 73.5%, or between 71% and 73%. Preferably, the weight content of 2,3,3,3-tetrafluoropropene in the composition according to the invention is comprised between 69% and 74%, particularly between 69.5% and 72.5%, advantageously between 70% and 72.5%, even more advantageously between 70.1% and 72.5%, and in a preferred manner between 70.1% and 72.1%.

Preferably, the weight content of difluoromethane in the composition according to the invention is comprised for example between 16% and 21.5%, 16% and 21%, 16% and 20.5%, 16% and 20%, 16.5% and 22%, 16.5% and 21.5%, 16.5% and 21%, 16.5% and 20.5%, 16.5% and 20%, 17% and 22%, 17% and 21.5%, 17% and 21%, 17% and 20.5%, 17% and 20%, 17.5% and 22%, 17.5% and 21.5%, 17.5% and 21%, 17.5% and 20.5%, 17.5% and 20%, 18% and 22%, 18% and 21.5%, 18% and 21%, 18% and 20.5%, 18% and 20%, 18.5% and 22%, 18.5% and 21.5%, 18.5% and 21%, 18.5% and 20.5%, 19% and 21.5%, 19% and 21%, 19% and 20%, 19% and 19.5%, 19.5% and 22%, 19.5% and 21.5%, 19.5% and 21%, 19.5% and 20.5%, 19.5% and 20%, 20% and 22%, 20% and 21.5%, 20% and 21%, 20% and 20.5%, or between 21% and 22%. Preferably, the weight content of HFC-32 in the composition is: 16%, 16.5%, 17%, 17.5%, 18%, 18.5%, 19%, 19.5%, 20%, 20.5%, 21%, 21.5% or 22%.

Preferably, the weight content of HFC-32 in the composition is comprised between 20% and 22.5%, and preferably between 20.5 and 22.5%.

According to one embodiment, the composition according to the invention comprises (is preferably constituted of) from 69% to 78% by weight of 2,3,3,3-tetrafluoropropene, from 16% to 22% by weight of difluoromethane, and from 2.1 to 9% by weight of propane, relative to the total weight of the composition.

According to one embodiment, the composition according to the invention comprises (is preferably constituted of) from 69% to 78% by weight of 2,3,3,3-tetrafluoropropene, from 19% to 22% by weight of difluoromethane, and from 2.1 to 9% by weight of propane, relative to the total weight of the composition.

According to one embodiment, the composition according to the invention comprises (is preferably constituted of) from 69% to 78% by weight of 2,3,3,3-tetrafluoropropene, from 19% to 22% by weight of difluoromethane, and from 3% to 9% by weight of propane, relative to the total weight of the composition.

According to one embodiment, the composition according to the invention comprises (is preferably constituted of) from 69% to 78% by weight of 2,3,3,3-tetrafluoropropene, from 16% to 22% by weight of difluoromethane, and from 3% to 9% by weight of propane, relative to the total weight of the composition.

According to one embodiment, the composition according to the invention comprises (is preferably constituted of) from 69% to 78% by weight of 2,3,3,3-tetrafluoropropene, from 16% to 22% by weight of difluoromethane, and from 4% to 9% by weight of propane, relative to the total weight of the composition.

According to one embodiment, the composition according to the invention comprises (is preferably constituted of) from 69% to 78% by weight of 2,3,3,3-tetrafluoropropene, from 16% to 22% by weight of difluoromethane, and from 5% to 9% by weight of propane, relative to the total weight of the composition.

According to one preferred embodiment, the composition comprises (is preferably constituted of) from 69% to 78% by weight of 2,3,3,3-tetrafluoropropene, from 16% to 22% by weight of difluoromethane, and from 6% to 9% by weight of propane, relative to the total weight of the composition.

According to one embodiment, the composition according to the invention comprises (is preferably constituted of) from 69% to 78% by weight of 2,3,3,3-tetrafluoropropene, from 16% to 22% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 69% to 77% by weight of 2,3,3,3-tetrafluoropropene, from 16% to 22% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 69% to 77% by weight of 2,3,3,3-tetrafluoropropene, from 17% to 22% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 69% to 76% by weight of 2,3,3,3-tetrafluoropropene, from 18% to 22% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 69% to 75% by weight of 2,3,3,3-tetrafluoropropene, from 19% to 22% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 69% to 74% by weight of 2,3,3,3-tetrafluoropropene, from 19% to 22% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 69% to 73% by weight of 2,3,3,3-tetrafluoropropene, from 19% to 22% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 69.5% to 72.5% by weight of 2,3,3,3-tetrafluoropropene, from 19.5% to 21.5% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 69.5% to 74% by weight of 2,3,3,3-tetrafluoropropene, from 19% to 21.5% by weight of difluoromethane, and from 6% to 9% by weight of propane, and particularly propane in one of the following contents: 6%, 6.5%, 7%, 7.5%, 8%, 8.5% or 9% relative to the total weight of the composition.

According to one embodiment, the composition according to the invention comprises (is preferably constituted of) from 70% to 72.5% by weight of 2,3,3,3-tetrafluoropropene, from 20% to 22.5% by weight of difluoromethane, and from 6.5% to 9% by weight of propane.

According to one embodiment, the composition according to the invention comprises (is preferably constituted of) from 70.1% to 72.1% by weight of 2,3,3,3-tetrafluoropropene, from 20.5% to 22.5% by weight of difluoromethane, and from 7% to 8.8% by weight of propane.

According to one embodiment, the composition according to the invention comprises (is preferably constituted of) from 70.1% to 72.1% by weight of 2,3,3,3-tetrafluoropropene, from 20.5% to 21.5% by weight of difluoromethane, and from 7% to 8% by weight of propane.

According to one embodiment, the composition according to the invention comprises (is preferably constituted of) from 71% to 72% by weight of 2,3,3,3-tetrafluoropropene, from 20.5% to 21.5% by weight of difluoromethane, and from 7.5% to 8% by weight of propane.

Preferred compositions according to the invention are as follows:
69.7% by weight of 2,3,3,3-tetrafluoropropene, 21.4% by weight of difluoromethane, and 8.9% by weight of propane,
70.7% by weight of 2,3,3,3-tetrafluoropropene, 21.4% by weight of difluoromethane, and 7.9% by weight of propane,
71.7% by weight of 2,3,3,3-tetrafluoropropene, 21.4% by weight of difluoromethane, and 6.9% by weight of propane,
70% by weight of 2,3,3,3-tetrafluoropropene, 21% by weight of difluoromethane, and 9% by weight of propane,
69.5% by weight of 2,3,3,3-tetrafluoropropene, 21.5% by weight of difluoromethane, and 9% by weight of propane,
71% by weight of 2,3,3,3-tetrafluoropropene, 20% by weight of difluoromethane, and 9% by weight of propane,
70.5% by weight of 2,3,3,3-tetrafluoropropene, 21.5% by weight of difluoromethane, and 8% by weight of propane,
71% by weight of 2,3,3,3-tetrafluoropropene, 21% by weight of difluoromethane, and 8% by weight of propane,
72% by weight of 2,3,3,3-tetrafluoropropene, 20% by weight of difluoromethane, and 8% by weight of propane,
73% by weight of 2,3,3,3-tetrafluoropropene, 19% by weight of difluoromethane, and 8% by weight of propane,
71.5% by weight of 2,3,3,3-tetrafluoropropene, 21.5% by weight of difluoromethane, and 7% by weight of propane,
72% by weight of 2,3,3,3-tetrafluoropropene, 21% by weight of difluoromethane, and 7% by weight of propane,
73% by weight of 2,3,3,3-tetrafluoropropene, 20% by weight of difluoromethane, and 7% by weight of propane,
72.5% by weight of 2,3,3,3-tetrafluoropropene, 21.5% by weight of difluoromethane, and 6% by weight of propane,
73% by weight of 2,3,3,3-tetrafluoropropene, 21% by weight of difluoromethane, and 6% by weight of propane,
74% by weight of 2,3,3,3-tetrafluoropropene, 20% by weight of difluoromethane, and 6% by weight of propane,
75% by weight of 2,3,3,3-tetrafluoropropene, 20% by weight of difluoromethane, and 5% by weight of propane,
71.1% by weight of 2,3,3,3-tetrafluoropropene (±1.0%), 21% by weight of difluoromethane (+0.5%, −1.5%), and 7.9% by weight of propane (+0.1%, −0.9%).

The compositions according to the invention are advantageously inflammable.

The compositions according to the invention advantageously have a lower flammability limit (known as LFL) greater than 100 g/m³, preferably greater than or equal to 150 g/m³, preferably greater than or equal to 155 g/m³, advantageously greater than or equal to 160 g/m³, even more advantageously greater then or equal to 170 g/m³, and particularly greater than or equal to 180 g/m³.

The composition according to the invention leads advantageously to a composition having a lower flammability limit greater than 100 g/m³, preferably greater than or equal to 150 g/m³, preferably greater than or equal to 155 g/m³, advantageously greater than or equal to 160 g/m³, even more advantageously greater then or equal to 162 g/m³, in a preferred manner greater than or equal to 170 g/m³ and particularly greater than or equal to 180 g/m³.

The composition according to the invention leads advantageously to a WCFF composition having a lower flammability limit greater than 100 g/m³.

The compositions according to the invention, the corresponding WCF and WCFF, have a heat of combustion (HOC) less than 19,000 kJ/m³. The heat of combustion according to the invention is defined and determined as indicated in standard ASHRAE 34-2013.

The “lower flammability limit” is defined in standard ASHRAE 34-2013 as being the minimum concentration of a composition that can propagate a flame through a homogeneous mixture of the composition and air, in test conditions specified in standard ASTM E681-04. It can be given for example in kg/m³ or in vol %.

A composition called “WCF” (worst case of formulation for flammability) is defined in standard ASHRAE 34-2013 as being a formulation composition whose flame propagation rate is the highest. This composition is very similar to the nominal composition (said nominal composition corresponding in the scope of the invention to a composition according to the invention) with a certain tolerance.

A composition called WCFF (worst case of fractionation for flammability) is defined in standard ASHRAE 34-2013 as being the composition whose flame propagation rate is highest. This composition is determined according to a method well defined in the same standard.

The compositions according to the invention advantageously have a good compromise between good energy performance, low or nil flammability, and low GWP, preferably a GWP below 150. The GWP can be calculated according to the indications provided by the 4th report of the Intergovernmental Panel on Climate Change (IPCC). The GWP of mixtures is specifically calculated as a function of the concentration by mass and the GWP of each component. The GWP of pure compounds are typically listed in the European F-Gas Directive (Regulation (EU) No 517/2014 of the European Parliament and Council of Apr. 16, 2014).

Because of their low flammability, the compositions according to the invention are advantageously safer when they are used as heat transfer fluids in refrigeration, air conditioning and for heating. What is more, heat transfer installations (refrigeration, air conditioning, heat pumps, etc.) may advantageously comprise higher loads of the composition according to the invention, because of their low flammability. Regarding the load limits, reference can typically be made to standard EN378 published in 2008-2009.

In the scope of the present invention, the flammability and lower flammability limit are defined and determined according to the test in standard ASHRAE 34-2013, which refers to standard ASTM E681 for the device used.

The different compositions tested are qualified as flammable or non-flammable as is, according to the criteria defined in standard ASHRAE 34-2013.

The composition used according to the invention is advantageously class 2 according to standard ASHRAE 34-2013. According to this standard, classification 2 specifically requires that the compositions have a lower flammability limit greater than 100 g/m³.

The composition according to the invention can be prepared by any known process, such as for example by simple mixing of the various compounds together.

### Heat Transfer Composition

According to one embodiment, the composition according to the invention is a heat transfer fluid.

The present invention also relates to a heat transfer composition comprising (preferably constituted of) the composition according to the invention, and at least one additive in particular chosen from nanoparticles, stabilizers, surfactants, tracers, fluorescent agents, odorants, lubricants and solubilization agents. Preferably the additive is chosen from lubricants, and in particular lubricants containing polyol esters.

The additives may in particular be chosen from nanoparticles, stabilizers, surfactants, tracers, fluorescent agents, odorants, lubricants and solubilization agents.

“Heat transfer compound,” respectively “heat transfer fluid” or “refrigerant fluid,” is understood to mean a compound, respectively a fluid, that can absorb heat by evaporating at low temperature and low pressure and reject heat by condensing at high temperature and high pressure, in a vapor compression circuit. Generally, a heat transfer fluid may comprise one, two, three or more heat transfer compounds.

“Heat transfer composition” is understood to mean a composition comprising a heat transfer fluid and optionally one or more additives that are not heat transfer compounds for the application envisaged.

The stabilizer or stabilizers, when they are present, represent preferably at most 5% by mass in the heat transfer composition. Among stabilizers, mention may in particular be made of nitromethane, ascorbic acid, terephthalic acid, azoles such as tolutriazole or benzotriazole, phenolic compounds such as tocopherol, hydroquinone, t-butyl hydroquinone, 2,6-di-tert-butyl-4-methylphenol, epoxides (alkyl optionally fluorinated or perfluorinated or alkenyl or aromatic) such as n-butyl glycidyl ether, hexanediol diglycidyl ether, allyl glycidyl ether, butylphenylglycidyl ether, phosphites, phosphonates, thiols and lactones.

As nanoparticles the following can be used: carbon nanoparticles, metal oxides (copper, aluminum), TiO₂, Al₂O₃, MoS₂, etc.

As tracers (that can be detected), mention may be made of deuterated or non-deuterated hydrofluorocarbons, deuterated hydrocarbons, perfluorocarbons, fluoroethers, bromine-containing compounds, iodine-containing compounds, alcohols, aldehydes, ketones, nitrous oxide and combinations thereof. The tracer is different from the heat transfer compound or compounds composing the heat transfer fluid.

As solubilization agents, mention may be made of hydrocarbons, dimethylether, polyoxyalkylene ethers, amides, ketones, nitriles, chlorocarbons, esters, lactones, aryl ethers, fluoroethers and 1,1,1-trifluoroalkanes. The solubilization agent is different from the heat transfer compound or compounds composing the heat transfer fluid.

As fluorescent agents, mention may be made of naphthalimides, perylenes, coumarins, anthracenes, phenanthracenes, xanthenes, thioxanthenes, naphthoxanhtenes, fluoresceins and derivatives and combinations thereof.

As odorants, mention may be made of alkylacrylates, allylacrylates, acrylic acids, acrylesters, alkylethers, alkylesters, alkynes, aldehydes, thiols, thioethers, disulfides, allylisothiocyanates, alkanoic acids, amines, norbornenes, norbornene derivatives, cyclohexene, heterocyclic aromatic compounds, ascaridole, o-methoxy(methyl)-phenol and combinations thereof.

In the scope of the invention, the terms “lubricant,” “lubricant oil” and “lubrication oil” are used interchangeably.

As lubricants the following may in particular be used: mineral oils, silicone oils, paraffins of natural origin, naphthenes, synthetic paraffins, alkylbenzenes, poly-alpha olefins, polyalkene glycols, polyol esters and/or polyvinylethers.

According to one embodiment, the lubricant contains polyol esters. Specifically, the lubricant comprises one or more polyol esters.

According to one embodiment, the polyol esters are obtained by reacting at least one polyol with a carboxylic acid or with a mixture of carboxylic acids.

In the scope of the invention, the term “carboxylic acid” covers both monocarboxylic and polycarboxylic acids, such as for example dicarboxylic acids.

In the scope of the invention, and unless otherwise stated, “polyol” is understood to mean a compound containing at least two hydroxyl (—OH) groups.

Polyol Esters A)

According to one embodiment, the polyol esters according to the invention meet the following formula (I):

R¹[OC(O)R²]ₙ (I)

wherein:
R¹ is a linear or branched hydrocarbon substituent, optionally substituted by at least one hydroxyl group and/or comprising at least one heteroatom chosen from the group constituted by —O—, —N—, and —S—;
each R² is, independently of each other, chosen from the group constituted by:
   i) H;
   ii) an aliphatic hydrocarbon substituent;
   ii) a branched hydrocarbon substituent;
   iv) a mixture of a substituent ii) and/or iii), with an aliphatic hydrocarbon substituent comprising from 8 to 14 carbon atoms; and
n is an integer of at least 2.

In the scope of the invention, hydrocarbon substituent is understood to mean a substituent composed of carbon and hydrogen atoms.

According to one embodiment, the polyols have the following general formula (II):

R¹(OH)ₙ (II)

wherein:
R¹ is a linear or branched hydrocarbon substituent, optionally substituted by at least one hydroxyl group, preferably by two hydroxyl groups, and/or comprising at least one heteroatom chosen from the group constituted by —O—, —N—, and —S—; and
n is an integer of at least 2.

Preferably, R¹ represents a linear or branched hydrocarbon group, comprising from 4 to 40 carbon atoms and preferably from 4 to 20 carbon atoms.

Preferably, R¹ is a linear or branched hydrocarbon substituent, comprising at least one oxygen atom.

Preferably, R¹ is a branched hydrocarbon substituent comprising from 4 to 10 carbon atoms, preferably 5 carbon atoms, substituted by two hydroxyl groups.

According to a preferred embodiment, polyols comprise from 2 to 10 hydroxyl groups, preferably from 2 to 6 hydroxyl groups.

The polyols according to the invention may comprise one or more oxyalkylene groups, in this specific case polyetherpolyols.

The polyols according to the invention may also comprise one or more nitrogen atoms. For example, the polyols may be alkanol amines containing from 3 to 6 OH groups. Preferably, the polyols are alkanol amines containing at least two OH groups, and preferably at least three.

According to the present invention, the preferred polyols are chosen from the group constituted of ethylene glycol, diethylene glycol, triethylene glycol, propylene glycol, dipropylene glycol, glycerol, neopentyl glycol, 1,2-butanediol, 1,4-butanediol, 1,3-butanediol, pentaerythritol, dipentaerythritol, tripentaerythritol, triglycerol, trimethylolpropane, sorbitol, hexaglycerol, and mixtures thereof. Preferably, the polyol is pentaerythritol or dipentaerythritol.

According to the invention, the carboxylic acids may have the following general formula (III):

R²COOH (III)

wherein:
R² is chosen from the group constituted of:
   i) H;
   ii) an aliphatic hydrocarbon substituent;
   ii) a branched hydrocarbon substituent;
   iv) a mixture of a substituent ii) and/or iii), with an aliphatic hydrocarbon substituent comprising from 8 to 14 carbon atoms.

Preferably, R² is an aliphatic hydrocarbon substituent, comprising from 1 to 10, preferably from 1 to 7 carbon atoms, and particularly from 1 to 6 carbon atoms.

Preferably, R² is a branched hydrocarbon substituent comprising from 4 to 20 carbon atoms, particularly from 5 to 14 carbon atoms, and preferably from 6 to 8 carbon atoms.

According to a preferred embodiment, a branched hydrocarbon substituent has the following formula (IV):

—C(R³)R⁴)(R⁵) (IV)

wherein R³, R⁴ and R⁵ are, independently of each other, an alkyl group, and at least one of the alkyl groups contains at least two carbon atoms. Such branched groups, once bound to the carboxyl group, are known by the name “neo group” and the corresponding acid is known as “neo acid.” Preferably, R³ and R⁴ are methyl groups and R¹⁰ is an alkyl group comprising at least two carbon atoms.

According to the invention, the R² substituent may comprise one or more carboxyl groups, or ester groups such as —COOR⁶, where R⁶ represents an alkyl, hydroxyalkyl substituent or a hydroxyalkyloxy alkyl group.

Preferably, the acid R²COOH having the formula (III) is a monocarboxylic acid.

Examples of carboxylic acids in which the hydrocarbon substituent is aliphatic are in particular: formic acid, acetic acid, propionic acid, butyric acid, pentanoic acid, hexanoic acid and heptanoic acid.

Examples of carboxylic acids in which the hydrocarbon substituent is branched are in particular: 2-ethyl-n-butyric acid, 2-hexyldecanoic acid, isostearic acid, 2-methyl-hexanoic acid, 2-methylbutanoic acid, 3-methylbutanoic acid, 3,5,5-trimethyl-hexanoic acid, 2-ethylhexanoic acid, neoheptanoic acid, and neodecanoic acid.

The third type of carboxylic acid that can be used in the preparation of polyol esters having the formula (I) are carboxylic acids comprising an aliphatic hydrocarbon substituent comprising from 8 to 14 carbon atoms. For example, the following can be cited: decanoic acid, dodecanoic acid, lauric acid, stearic acid, myristic acid, behenic acid, etc. Among dicarboxylic acids, mention may be made of maleic acid, succinic acid, adipic acid, sebacic acid, etc.

According to a preferred embodiment, the carboxylic acids used for preparing polyol esters having the formula (I) comprise a mixture of monocarboxylic and dicarboxylic acids, the proportion of monocarboxylic acids being in the majority. The presence of dicarboxylic acids results in particular in the formation of polyol esters with high viscosity.

Specifically, the reaction for the formation of polyol esters having the formula (I) by reaction between the carboxylic acid and polyols is a reaction catalyzed by an acid. This is in particular a reversible reaction, which can be complete through the use of a large quantity of acid or by the elimination of water formed during the reaction.

The esterification reaction can be conducted in the presence of organic or inorganic acids, such as sulfuric acid, phosphoric acid, etc.

Preferably, the reaction is conducted in the absence of catalyst.

The quantity of carboxylic acid and polyol may vary in the mixture according to the desired result. In the specific case where all the hydroxyl groups are esterified, a sufficient quantity of carboxylic acid must be added to react with all the hydroxyls.

According to one embodiment, when mixtures of carboxylic acids are used, they may react sequentially with the polyols.

According to a preferred embodiment, when mixtures of carboxylic acids are used, a polyol reacts first with one carboxylic acid, typically the carboxylic acid with the highest molecular weight, followed by reaction with the carboxylic acid with an aliphatic hydrocarbon chain.

According to one embodiment, the esters may be formed by reaction between carboxylic acids (or their anhydride or ester derivatives) with polyols, in the presence of acids at high temperature, while removing the water formed during the reaction. Typically, the reaction may be conducted at a temperature comprised from 75 to 200° C.

According to another embodiment, the polyol esters formed may comprises hydroxyl groups that have not all reacted, which in this case is partially esterified polyol esters.

According to a preferred embodiment, the polyol esters are obtained from the alcohol pentaerythritol, and from a mixture of carboxylic acids:isononanoic acid, at least one acid having an aliphatic hydrocarbon substituent comprising from 8 to 10 carbon atoms, and heptanoic acid. The preferred polyol esters are obtained from pentaerythritol, and from a mixture of 70% isononanoic acid, 15% of at least one carboxylic acid having an aliphatic hydrocarbon substituent comprising from 8 to 10 carbon atoms, and 15% of heptanoic acid. For example, the oil Solest 68 sold by CPI Engineering Services Inc. can be cited.

According to a preferred embodiment, the polyol esters are obtained from the alcohol dipentaerythritol, and from a mixture of carboxylic acids:isononanoic acid, at least one acid having aliphatic hydrocarbon substituent comprising from 8 to 10 carbon atoms, and heptanoic acid.

Preferably, the polyol esters of the invention have one of the following formulas (I-A) or (I-B):

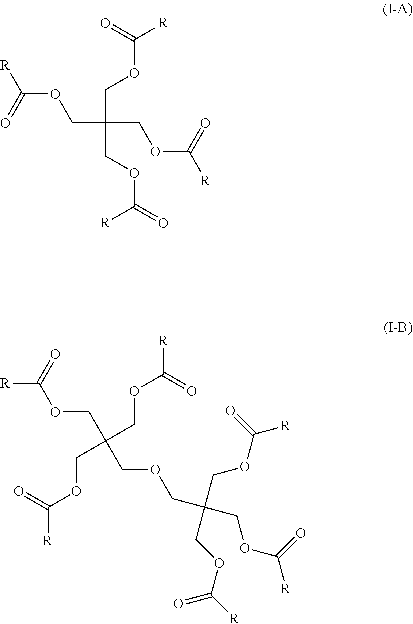

wherein each R represents, independently of each other:
an aliphatic hydrocarbon substituent comprising from 1 to 10, preferably from 2 to 9, preferably from 4 to 9 carbon atoms, and particularly from 1 to 6 carbon atoms.
a branched hydrocarbon substituent comprising from 4 to 20 carbon atoms, particularly from 4 to 14 carbon atoms, and preferably from 4 to 9 carbon atoms.

Specifically, the polyol esters having the formula (I-A) or the formula (I-B) comprise different R substituents.

One preferred polyol ester is an ester having the formula (I-A) wherein R is chosen from:
an aliphatic hydrocarbon substituent comprising 4 carbon atoms; and/or
an aliphatic hydrocarbon substituent comprising 6 carbon atoms; and/or
an aliphatic hydrocarbon substituent comprising 7 carbon atoms; and/or
an aliphatic hydrocarbon substituent comprising 8 carbon atoms; and/or
an aliphatic hydrocarbon substituent comprising 9 carbon atoms; and/or
a branched hydrocarbon substituent comprising 4 carbon atoms; and/or
a branched hydrocarbon substituent comprising 5 carbon atoms; and/or
a branched hydrocarbon substituent comprising 7 carbon atoms; and/or
a branched hydrocarbon substituent comprising 8 carbon atoms; and/or
a branched hydrocarbon substituent comprising 9 carbon atoms.

One preferred polyol ester is an ester having the formula (I-B) wherein R is chosen from:
an aliphatic hydrocarbon substituent comprising 4 carbon atoms; and/or
an aliphatic hydrocarbon substituent comprising 6 carbon atoms; and/or
an aliphatic hydrocarbon substituent comprising 7 carbon atoms; and/or
an aliphatic hydrocarbon substituent comprising 8 carbon atoms; and/or
an aliphatic hydrocarbon substituent comprising 9 carbon atoms; and/or
a branched hydrocarbon substituent comprising 4 carbon atoms; and/or
a branched hydrocarbon substituent comprising 5 carbon atoms; and/or
a branched hydrocarbon substituent comprising 7 carbon atoms; and/or
a branched hydrocarbon substituent comprising 8 carbon atoms; and/or
a branched hydrocarbon substituent comprising 9 carbon atoms.

Polyol Esters B)

According to another embodiment, the polyol esters of the invention comprise at least one ester of one or more branched carboxylic acids comprising at most 8 carbon atoms. The ester is in particular obtained by reaction of said branched carboxylic acid with one or more polyols.

Preferably, the branched carboxylic acid comprises at least 5 carbon atoms. Specifically, the branched carboxylic acid comprises from 5 to 8 carbon atoms, and preferably it contain 5 carbon atoms.

Preferably, the above-mentioned branched carboxylic acid does not comprise 9 carbon atoms. Specifically, said carboxylic acid is not 3,5,5-trimethylhexanoic acid.

According to a preferred embodiment, the branched carboxylic acid is chose from 2-methylbutanoic acid, 3-methylbutanoic acid, and mixtures thereof.

According to a preferred embodiment, the polyol is chosen from the group constituted of neopentyl glycol, glycerol, trimethylol propane, pentaerythritol, dipentaerythritol, tripentaerythritol, and mixtures thereof.

According to a preferred embodiment, the polyol esters are obtained from:
i) a carboxylic acid chosen from 2-methylbutanoic acid, 3-methylbutanoic acid, and mixtures thereof; and
ii) a polyol chosen from the group constituted of neopentyl glycol, glycerol, trimethylol propane, pentaerythritol, dipentae, tripentaerythritol, and mixtures thereof.

Preferably, the polyol ester is that obtained from 2-methylbutanoic acid and pentaerythritol.

Preferably, the polyol ester is that obtained from 2-methylbutanoic acid and dipentaerythritol.

Preferably, the polyol ester is that obtained from 3-methylbutanoic acid and pentaerythritol.

Preferably, the polyol ester is that obtained from 3-methylbutanoic acid and dipentaerythritol.

Preferably, the polyol ester is that obtained from 2-methylbutanoic acid and neopentyl glycol.

Polyol Esters C)

According to another embodiment, the polyol esters according to the invention are poly(neopentylpolyol) esters obtained by:
i) reacting a neopentylpolyol having the following formula (V):

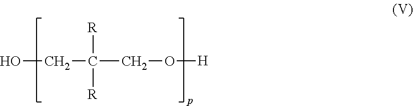

wherein:
each R represents, independently of each other, CH₃, C₂H₅ or CH₂OH;
p is an integer ranging from 1 to 4;
with at least one monocarboxylic acid having from 2 to 15 carbon atoms, and in the presence of an acid catalyst, where the molar ratio of carboxyl groups and hydroxyl groups is less than 1:1, to form a partially esterified poly(neopentyl)polyol composition; and
ii) reacting the partially esterified poly(neopentyl)polyol composition obtained from step i) with another carboxylic acid having from 2 to 15 carbon atoms, to form the final composition of poly(neopentylpolyol) ester(s).

Preferably, reaction i) is conducted with a molar ratio ranging from 1:4 to 1:2.

Preferably, the neopentylpolyol has the following formula (VI):

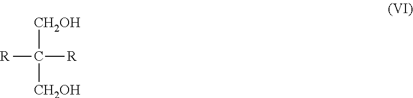

wherein each R represents, independently of each other, CH₃, C₂H₅ or CH₂OH.

Preferred neopentylpolyols are those chosen from pentaerythritol, dipentaerythritol, tripentaerythritol, tetraerythritol, trimethylolpropane, tri methylolethane, and neopentyl glycol. Specifically, the neopentylpolyol is pentaerythritol.

Preferably, a single neopentylpolyol is used to produce the lubricant containing POE. In some cases, two or more neopentylpolyols are used. This is in particular the case when a commercial pentaerythritol product comprises low quantities of dipentaerythritol, tripentaerythritol, and tetraerythritol.

According to a preferred embodiment, the above-mentioned monocarboxylic acid comprises from 5 to 11 carbon atoms, preferably from 6 to 10 carbon atoms.

The monocarboxylic acids in particular have the following general formula (VII):

R′C(O)OH (VII)
wherein R′ is a linear or branched C1-C12 alkyl substituent, a C6-C12 aryl substituent, a C6-C30 aralkyl substituent. Preferably, R′ is a C4-C10, and preferably C5-C9, alkyl substituent.

Specifically, the monocarboxylic acid is chosen from the group constituted of butanoic acid, pentanoic acid, hexanoic acid, heptanoic acid, n-octanoic acid, n-nonanoic acid, n-decanoic acid, 3-methylbutanoic acid, 2-methylbutanoic acid, 2,4-dimethylpentanoic acid, 2-ethylhexanoic acid, 3,3,5-trimethylhexanoic acid, benzoic acid, and mixtures thereof.

According to a preferred embodiment, the monocarboxylic acid is n-heptanoic acid, or a mixture of n-heptanoic acid with another linear monocarboxylic acid, particularly n-octanoic acid and/or n-decanoic acid. Such a mixture of monocarboxylic acid may comprise between 15 and 100 mol % of heptanoic acid and between 85 and 0 mol % of other monocarboxylic acid(s). Specifically, the mixture comprises between 75 and 100 mol % of heptanoic acid, and between 25 and 0 mol % of a mixture of octanoic acid and decanoic acid in a 3:2 molar ratio.

According to a preferred embodiment, the polyol esters comprise:
i) from 45% to 55% by weight of a monopentaerythritol ester with at least one monocarboxylic acid having from 2 to 15 carbon atoms;
ii) less than 13% by weight of a dipentaerythritol ester with at least one monocarboxylic acid having from 2 to 15 carbon atoms;
iii) less than 10% by weight of a tripentaerythritol ester with at least one monocarboxylic acid having from 2 to 15 carbon atoms; and
iv) at least 25% by weight of a tetraerythritol ester and other pentaerythritol oligomers, with at least one monocarboxylic acid having from 2 to 15 carbon atoms.

Polyol Esters D)

According to another embodiment, the polyol esters according to the invention have the following formula (VIII):

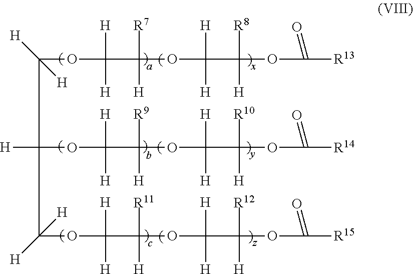

wherein:
R⁷, R⁸, R⁹, R¹⁰, R¹¹ and R¹² are, independently of each other, H or CH₃;
a, b, c, y, x and z, are, independently of each other, an integer;
a+x, b+y, and c+z are, independently of each other, integers ranging from 1 to 20;
R¹³, R¹⁴ and R¹⁵ are, independently of each other, chosen from the group constituted of aliphatic or branched alkyls, alkenyls, cycloalkyls, aryls, alkylaryls, arylalkyls, alkylcycloalkyls, cycloalkylalkyls, arylcycloalkyls, cycloalkylaryls, alkylcycloalkylaryls, alkylarylcycloalkyls, arylcycloalkylalkyls, arylalkylcycloalkyls, cycloalkylalkylaryls and cycloalkylarylalkyls,
R¹³, R¹⁴ and R¹⁵, having from 1 to 17 carbon atoms, and being optionally substituted.

According to a preferred embodiment, each of R¹³, R¹⁴ and R¹⁵ represents, independently of each other, a linear or branched alkyl group, an alkenyl group, a cycloalkyl group, where said alkyl, alkenyl or cycloalkyl groups may comprise at least one heteroatom chosen from N, O, Si, F or S. Preferably, each of R¹³, R¹⁴ and R¹⁵ has, independently of each other, from 3 to 8 carbon atoms, preferably from 5 to 7 carbon atoms.

Preferably, a+x, b+y, and c+z are, independently of each other, integers ranging from 1 to 10, preferably from 2 to 8, and even more preferably from 2 to 4.

Preferably, R⁷, R⁸, R⁹, R¹⁰, R¹¹ and R¹² represent H.

Polyol esters having the formula (VIII) above may typically be prepared as described in paragraphs [0027] to [0030] of the international application WO2012/177742.

Specifically, polyol esters having the formula (VIII) are obtained by the esterification of glycerol alkoxylates (as described in paragraph [0027] of WO2012/177742) with one or more monocarboxylic acids having from 2 to 18 carbon atoms.

According to a preferred embodiment, the monocarboxylic acids have one of the following formulas:

R¹³COOH

R¹⁴COOH and

R¹⁵COOH

wherein R¹³, R¹⁴ and R¹⁵ are as defined above. Carboxylic acid derivatives can also be used, such as anhydrides, esters and acyl halides.

The esterification can be conducted with one or more monocarboxylic acids. Preferred monocarboxylic acids are those chosen from the group constituted of acetic acid, propanoic acid, butyric acid, isobutanoic acid, pivalic acid, pentanoic acid, isopentanoic acid, hexanoic acid, heptanoic acid, octanoic acid, 2-ethylhexanoic acid, 3,3,5-trimethylhexanoic acid, nonanoic acid, decanoic acid, neodecanoic acid, undecanoic acid, dodecanoic acid, tridecanoic acid, myristic acid, pentadecanoic acid, palmitic acid, stearic acid, oleic acid, linoleic acid, palmitoleic acid, citronellic acid, undecenoic acid, lauric acid, undecylenic acid, linolenic acid, arachidic acid, behenic acid, tetrahydrobenzoic acid, abietic acid, hydrogenated or non-hydrogenated, 2-ethylhexanoic acid, furoic acid, benzoic acid, 4-acetylbenzoic acid, pyruvic acid, 4-tert-butyl-benzoic acid, naphthenic acid, 2-methyl benzoic acid, salicylic acid, isomers thereof, methyl esters thereof, and mixtures thereof.

Preferably, the esterification is conducted with one or more monocarboxylic acids chosen from the group constituted of pentanoic acid, 2-methylbutanoic acid, n-hexanoic acid, n-heptanoic acid, 3,3,5-trimethylhexanoic acid, 2-ethylhexanoic acid, n-octanoic acid, n-nonanoic acid and isononanoic acid.

Preferably, the esterification is conducted with one or more monocarboxylic acids chosen from the group constituted of butyric acid, isobutyric acid, n-pentanoic acid, 2-methylbutanoic acid, 3-methylbutanoic acid, n-hexanoic acid, n-heptanoic acid, n-octanoic acid, 2-ethylhexanoic acid, 3,3,5-trimethylhexanoic acid, n-nonanoic acid, decanoic acid, undecanoic acid, undecelenic acid, lauric acid, stearic acid, isostearic acid, and mixtures thereof.

According to another embodiment, the polyol esters according to the invention have the following formula (IX):

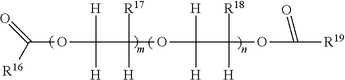

wherein:
each of R¹⁷ and R¹⁸ is, independently of each other, H or CH₃;
each of m and n is, independently of each other, an integer, where m+n is an integer ranging from 1 to 10;
R¹⁶ and R¹⁹ are, independently of each other, chosen from the group constituted of aliphatic or branched alkyls, alkenyls, cycloalkyls, aryls, alkylaryls, arylalkyls, alkylcycloalkyls, cycloalkylalkyls, arylcycloalkyls, cycloalkylaryls, alkylcycloalkylaryls, alkylarylcycloalkyls, arylcycloalkylalkyls, arylalkylcycloalkyls, cycloalkylalkylaryls and cycloalkylarylalkyls,
R¹⁶ and R¹⁹, having from 1 to 17 carbon atoms, and being optionally substituted.

According to a preferred embodiment, each of R¹⁶ and R¹⁹ represents, independently of each other, a linear or branched alkyl group, an alkenyl group, a cycloalkyl group, where said alkyl, alkenyl or cycloalkyl groups may comprise at least one heteroatom chosen from N, O, Si, F or S. Preferably, each of R¹⁶ and R¹⁹ has, independently of each other, from 3 to 8 carbon atoms, preferably from 5 to 7 carbon atoms.

According to a preferred embodiment, each of R¹⁷ and R¹⁸ represents H, and/or m+n is an integer ranging from 2 to 8, from 4 to 10, from 2 to 5, or from 3 to 5. Specifically, m+n is 2, 3 or 4.

According to a preferred embodiment, polyol esters having the formula (IX) above are diesters of triethylene glycol, diesters of tetraethylene glycol, particularly with one or two monocarboxylic acids having from 4 to 9 carbon atoms.

The polyol esters having the formula (IX) above can be prepared by esterifications from an ethylene glycol, a propylene glycol, or an oligo- or polyalkylene glycol (which can be an oligo- or polyethylene glycol, oligo- or polypropylene glycol, or an ethylene glycol-propylene glycol block copolymer), with one or two monocarboxylic acids having from 2 to 18 carbon atoms. The esterification can be conducted in an identical manner to the esterification reaction used to prepare the polyol esters having the formula (VIII) above.

Specifically, monocarboxylic acids identical to those used to prepare polyol esters having the formula (VIII) above can be used to form polyol esters having the formula (IX).

According to one embodiment, the lubricant containing polyol esters according to the invention comprises from 20 to 80%, preferably from 30 to 70%, and preferably from 40 to 60% by weight of at least one polyol ester having the formula (VIII), and from 80 to 20%, preferably from 70 to 30%, and preferably from 60 to 40% by weight of at least one polyol ester having the formula (IX).

Generally, some alcohol functions may remain unesterified during the esterification reaction, but their proportion remains low. Accordingly, the POE may comprise between 0 and 5 mol % relative of CH₂OH units relative to the —CH₂—O—C(═O)— units.

The preferred POE lubricants according to the invention are those having a viscosity from 1 to 1000 centiStokes (cSt) at 40° C., preferably from 10 to 200 cSt, even more preferably from 20 to 100 cSt, and advantageously from 30 to 80 cSt.

The international classification of oils is in particular given by standard ISO3448-1992 (NF T60-141), where oils are denoted by their class of mean viscosity measured at the temperature of 40° C.

### Uses

The composition according to the present invention are particularly suitable as heat transfer fluid for refrigeration, air conditioning and heating.

The composition according to the present invention may be used in diverse applications for replacing current refrigerant fluids such as R455A (mixture of R32/R1234yf/CO₂: 21.5/75.5/3 mass %) or R454C (mixture of R1234yf/R32: 78.5/21.5 mass %), and advantageously without having to replace the compressor technology.

The present invention relates to the use of the composition according to the invention for reducing the risks of ignition and/or explosion in the event of a refrigerant leak.

The low flammability of the composition advantageously allows its use in larger quantities in heat transfer installations. The use of refrigerant fluids according to the classes is in particular described in standard ISO 5149-1 (version 2014).

The present invention also relates to the use of a composition according to the invention or of a heat transfer composition according to the invention, in a heat transfer system containing a vapor compression circuit.

According to one embodiment, the heat transfer system is:
an air conditioning system; or
a refrigeration system; or
a freezing system; or
a heat pump system.

The present invention also relates to a heat transfer process relying on the use of a heat transfer facility containing a vapor compression circuit that comprises the composition according to the invention or the heat transfer composition according to the invention. The heat transfer process can be a process for heating or cooling a fluid or a substance.

The composition according to the invention or the heat transfer composition can also be used in a process for the production of mechanical work or electricity, in particular in accordance with a Rankine cycle.

The invention also relates to a heat transfer installation comprising a vapor compression circuit containing the composition according to the invention or the heat transfer composition according to the invention.

According to one embodiment, this installation is chosen from mobile or stationary refrigeration, heating (heat pump), air conditioning and freezing installations, and combustion engines.

It may in particular be a heat pump installation, in which case the fluid or substance that is heated (generally air and optionally one or more products, objects or organisms) is located in a room or a vehicle cabin (for a mobile installation). According to a preferred embodiment, this is an air conditioning installation, in which case the fluid or substance that is cooled (generally air and optionally one or more products, objects or organisms) is located in a room or a vehicle cabin (for a mobile installation). It may in particular be a refrigeration installation or a freezing installation (or cryogenic installation), in which case the fluid or substance that is cooled generally comprises air and one or more products, objects or organisms located in a room or a container.

The invention also relates to a process for heating or cooling of a fluid or a substance using a vapor compression circuit containing a heat transfer fluid or a heat transfer composition, said process comprising successively the evaporation of the fluid or of the heat transfer composition, the compression of the fluid or of the heat transfer composition, the condensation of the fluid or of the heat transfer composition, and the relaxation of the fluid or of the heat transfer composition, wherein the heat transfer fluid is the composition according to the invention, or the heat transfer composition is that above.

The invention also relates to a process for producing electricity using a combustion engine, said process comprising successively the evaporation of the fluid or of a heat transfer composition, the relaxation of the fluid or of the heat transfer composition in a turbine that allows the generation of electricity, the condensation of the heat transfer fluid or composition and the compression of the heat transfer fluid or composition, wherein the heat transfer fluid is the composition according to the invention and the heat transfer composition is that described above.

The vapor compression circuit containing a heat transfer fluid or composition according to the invention comprises at least one evaporator, a compressor, preferably a screw compressor, a condenser and an expander, and lines for transporting the heat transfer fluid or composition between these elements. The evaporator and the condenser comprise a heat exchanger allowing an exchange of heat between the heat transfer fluid or composition and another fluid or substance.

The evaporator used in the scope of the invention can be a superheated evaporator or a flooded evaporator. In a superheated evaporator, all of the above-mentioned heat transfer fluid or composition is evaporated at the outlet of the evaporator, and the vapor phase is superheated.

In a flooded evaporator, the heat transfer fluid/composition in liquid form does not completely evaporate. A flooded evaporator includes a liquid phase and vapor phase separator.

As compressor, in particular a centrifugal compressor with one or more stages or a mini-centrifugal compressor can be used. Rotary, plunger and screw compressors can also be used.

According to one embodiment, the vapor compression circuit comprises a centrifugal compressor, and preferably a centrifugal compressor and a flooded evaporator.

According to another embodiment, the vapor compression circuit comprises a screw compressor, preferably bi-screw or mono-screw. Specifically, the vapor compression circuit comprises a bi-screw compressor that can use a substantial oil flow, for example up to 6.3 Us.

A centrifugal compressor is characterized in that it uses rotary elements to accelerate the heat transfer fluid or composition radially; it typically comprises at least one impeller and a diffuser housed in an enclosure. The heat transfer fluid or the heat transfer composition is added at the center of the impeller and circulates to the edge of the impeller while undergoing acceleration. Accordingly, first the static pressure increases in the impeller, and especially secondly in the diffuser, the rate is converted by increasing the static pressure. Each impeller/diffuser set constitutes one stage of the compressor. The centrifugal compressors may comprise from 1 to 12 stages, according to the desired final pressure and the volume of fluid to process.

The compression rate is defined as being the ratio of the absolute pressure of the heat transfer fluid/composition at the outlet over the absolute pressure of said composition at the input.

The rotation rate for large centrifugal compressors ranges from 3000 to 7000 rpm. Small centrifugal compressors (or mini-centrifugal compressors) generally operate at a rotation rate that ranges from 40,000 to 70,000 rpm and includes a small impeller (generally less than 0.15 m).

An impeller with several stages can be used to improve the compressor's efficacy and limit the energy cost (relative to an impeller with a single stage). For a system with two stages, the outlet of the first stage of the impeller feeds the inlet of the second impeller. The two impellers can be mounted on a single axis. Each stage can supply a compression rate for the fluid of about 4 over 1, i.e. the absolute pressure at the outlet can equal about four times the absolute pressure upon aspiration. Examples of two-stage centrifugal compressors, particularly for automotive applications, are described in documents U.S. Pat. Nos. 5,065,990 and 5,363,674. The centrifugal compressor can be driven by an electric motor or by a gas turbine (for example fed by the exhaust gases of a vehicle, for mobile applications) or by gears.

The installation may comprise a coupling of the extender with a turbine for generating electricity (Rankine cycle).

The installation may also optionally comprise at least one coolant fluid circuit used to transfer heat (with or without change of state) between the heat transfer fluid or heat transfer composition circuit, and the fluid or substance to be heated or cooled.

The installation may also optionally comprise two (or more) vapor compression circuits, containing identical or distinct heat transfer fluids/compositions. For example, the vapor compression circuits may be paired.

The vapor compression circuit operates according to a classic vapor compression cycle. The cycle comprises the change of state of the heat transfer fluid/composition from a liquid phase (or liquid/vapor biphase) to a vapor phase at a relatively low pressure, then the compression of the fluid/the composition in the vapor phase to a relatively high pressure, the change of state (condensation) of the heat transfer fluid/composition from the vapor phase to the liquid phase at a relatively high pressure, and the reduction of the pressure to restart the cycle.

For a cooling process, heat from the fluid or substance that is being cooled (directly or indirectly, via a coolant fluid) is absorbed by the heat transfer fluid/composition as it evaporates, and at a relatively low temperature relative to the surroundings. Cooling processes comprise air conditioning (with mobile installations, for example in vehicles, or stationary installations), refrigeration and freezing or cryogenic processes. In the field of air conditioning, mention may be made of domestic, commercial or industrial air conditioning, where the equipment used is either chillers, or direct expansion equipment. In the field of refrigeration, mention may be made of domestic and commercial refrigeration, cold rooms, the food industry, refrigerated freight (trucks, ships).

For a heating process, heat is surrendered (directly or indirectly, via a coolant fluid) from the heat transfer fluid/composition, as it condenses, to the fluid or substance that is heated, and at a relatively high temperature relative to the surroundings. The installation allowing the transfer of heat is then called a “heat pump.” This may in particular be average and high temperature heat pumps.

It is possible to use any type of heat exchanger to implement the compositions according to the invention or heat transfer composition according to the invention, and in particular co-current heat exchangers, or, preferably, counter-current heat exchangers.

However, according to a preferred embodiment, the invention provides that cooling and heating processes, and the corresponding installations, comprise a counter-current heat exchanger, either on the condenser, or on the evaporator. Indeed, the compositions according to the invention or heat transfer composition defined above are particularly effective with counter-current heat exchangers. Preferably, both the evaporator and the condenser comprise a counter-current heat exchanger.

According to the invention, “counter-current heat exchanger” is understood to mean a heat exchanger in which the heat is exchanged between a first fluid and a second fluid, the first fluid at the input of the exchanger exchanging heat with the second fluid at the outlet of the exchanger, and the first fluid at the outlet of the exchanger exchanging heat with the second fluid at the input of the exchanger.

For example, counter-current heat exchangers comprise devices in which the flow of the first fluid and the flow of the second fluid are in opposite, or almost opposite, directions. Exchangers operating in cross-current mode with counter-current tendency are also comprised among counter-current heat exchangers in the sense of the present application.

In “low temperature refrigeration” processes, the input temperature of the composition according to the invention or heat transfer composition, to the evaporator is preferably from −45° C. to −15° C., in from −40° C. to −20° C., in a particularly preferred manner from −35° C. to −25° C. and for example about −30° C. or −20° C.; and the temperature of the start of the condensation of the composition according to the invention or heat transfer compositions, at the condenser, is preferably from 25° C. to 80° C., in particular from 30° C. to 60° C., in a more particularly preferred manner from 35° C. to 55° C. and for example about 40° C.

In “moderate temperature cooling” processes, the input temperature of the composition according to the invention or heat transfer composition, to the evaporator is preferably from −20° C. to 10° C., in particular from −15° C. to 5° C., in a more particularly preferred manner from −10° C. to 0° C. and for example about −5° C.; and the temperature of the start of the condensation of the composition according to the invention or heat transfer composition, at the condenser is preferably from 25° C. to 80° C., in particular from 30° C. to 60° C., in a more particularly preferred manner from 35° C. to 55° C. and for example about 50° C. These processes can be refrigeration or air conditioning processes.

In “moderate temperature heating” processes, the input temperature of the composition according to the invention or heat transfer composition, to the evaporator is preferably from −20° C. to 10° C., in from −15° C. to 5° C., in a more particularly preferred manner from −10° C. to 0° C. and for example about −5° C.; and the temperature of the start of the condensation of the composition according to the invention or heat transfer composition, at the condenser is preferably from 25° C. to 80° C., in particular from 30° C. to 60° C., in a more particularly preferred manner from 35° C. to 55° C. and for example about 50° C.

All the embodiments described above may be combined together.

In the scope of the invention, “comprised between x and y,” or “from x to y,” are understood to mean an interval in which the limits x and y are included. For example, the range “comprised between 6 and 9%” includes the values 6 and 9% in particular.

The following examples illustrate the invention without limiting it.

### EXPERIMENTAL SECTION

### Example 1A

The following mixtures have been prepared from R32, R1234yf and propane, with a constant composition of 21.4 mass % of R32. The propane composition was varied from 2.4% to 8.9% by mass relative to the total mass of the composition.

| Nominal compositions | | | |
|---|---|---|---|
| R32 | R1234yf | Propane | LFL* (g/m³) |
| 21.40 | 69.70 | 8.90 | >160 |
| 21.40 | 70.70 | 7.90 | >160 |
| 21.40 | 71.70 | 6.90 | >180 |
| 21.40 | 72.70 | 5.90 | >180 |
| 21.40 | 73.70 | 4.90 | >180 |
| 21.40 | 74.70 | 3.90 | >180 |
| 21.40 | 75.20 | 3.40 | >180 |
| 21.40 | 75.70 | 2.90 | >180 |
| 21.40 | 75.90 | 2.70 | >180 |
| 21.40 | 76.20 | 2.40 | >180 |

*LFL to 23° C.

From the fractionation analysis by applying standard ASHRAE 34-2013, the most critical of these compositions (WCFF) is for a leak test at the boiling temperature+10° C. and for a filling of the cylinder at 90% in liquid phase at a temperature of 54.4° C. (ASHRAE STANDARD 34-2013 appendix B, paragraph B2).

The calculations were conducted with the software program Refprop, version 9.

The compositions and LFL after leaks (WCFF) are as follows:

| WCFF Compositions | | | |
|---|---|---|---|
| R32 | R1234yf | Propane | LFL* (g/m³) |
| 34.60 | 45.00 | 20.40 | >100 |
| 44.90 | 36.40 | 18.70 | >100 |
| 45.00 | 38.10 | 16.90 | >100 |
| 45.10 | 40.00 | 14.90 | >100 |
| 45.30 | 41.90 | 12.80 | >100 |
| 45.40 | 44.20 | 10.40 | >100 |
| 45.50 | 45.30 | 9.20 | >100 |
| 45.60 | 46.50 | 7.90 | >180 |
| 45.60 | 47.00 | 7.40 | >180 |
| 45.60 | 47.80 | 6.60 | >180 |

*LFL to 23° C.

### Example 1B

The composition with 19.9% R32, 72.1% R1234yf and 8% propane (mass %) was prepared in the laboratory. Applying standard ASHRAE 34-2013, the LFL of this composition was measured at 23° C.: the measurements give a value of LFL>160 g/m³.

### Example 2

A low temperature refrigeration installation operates between an average evaporation temperature at −35° C., an average condensation temperature of 45° C., a superheating of 10° C. and a subcooling at 5° C.

The isentropic yield of the compressor is 55%.

| | | | | | Temperature (° C.) | | | | | | |
|---|---|---|---|---|---|---|---|---|---|---|---|
| | | | | | | Evaporator | | | Condenser | Condenser | |
| Composition | | | P (bar) | | Evaporator | vapor | Evaporator | Compressor | vapor | liquid | Relaxer |
| (Mass %) | | | high | low | input | saturation | outlet | outlet | saturation | saturation | input |
| R455A | | | 20 | 1.4 | −38 | −32 | −22 | 125 | 50 | 40 | 35 |
| (R32/R1234yf/CO2 | | | | | | | | | | | |
| with 21.5% wt R32 | | | | | | | | | | | |
| and 3% CO2) | | | | | | | | | | | |
| R454C | | | 18 | 1.3 | −37 | −33 | −23 | 118 | 48 | 42 | 37 |
| (R32/R1234yf with | | | | | | | | | | | |
| 21.5% wt R32) | | | | | | | | | | | |
| R32 | R1234yf | propane | | | | | | | | | |
| 20 | 75 | 5 | 19 | 1.4 | −37 | −32 | −22 | 118 | 49 | 41 | 36 |
| 20 | 74 | 6 | 19 | 1.4 | −37 | −32 | −22 | 119 | 49 | 41 | 36 |
| 21 | 73 | 6 | 20 | 1.4 | −38 | −32 | −22 | 120 | 49 | 41 | 36 |
| 21.5 | 72.5 | 6 | 20 | 1.4 | −38 | −32 | −22 | 120 | 49 | 41 | 36 |
| 20 | 73 | 7 | 19 | 1.4 | −38 | −32 | −22 | 119 | 49 | 41 | 36 |
| 21 | 72 | 7 | 20 | 1.4 | −38 | −32 | −22 | 120 | 49 | 41 | 36 |
| 21.5 | 71.5 | 7 | 20 | 1.4 | −38 | −32 | −22 | 121 | 49 | 41 | 36 |
| 19 | 73 | 8 | 19 | 1.4 | −38 | −32 | −22 | 118 | 49 | 41 | 36 |
| 20 | 72 | 8 | 20 | 1.4 | −38 | −32 | −22 | 119 | 49 | 41 | 36 |
| 21 | 71 | 8 | 20 | 1.5 | −38 | −32 | −22 | 120 | 49 | 41 | 36 |
| 21.5 | 70.5 | 8 | 20 | 1.5 | −38 | −32 | −22 | 121 | 49 | 41 | 36 |
| 20 | 71 | 9 | 20 | 1.5 | −38 | −32 | −22 | 120 | 49 | 41 | 36 |
| 21 | 70 | 9 | 20 | 1.5 | −38 | −32 | −22 | 121 | 49 | 41 | 36 |
| 21.5 | 69.5 | 9 | 20 | 1.5 | −38 | −32 | −22 | 121 | 49 | 41 | 36 |

| Composition | | | | | | | | |
|---|---|---|---|---|---|---|---|---|
| (Mass %) | | | Temperature slip | pressure ratio | % CAP (cold) | % COP (cold) | % CAP (hot) | % COP (hot) |
| R455A | | | 5.4 | 14 | 100 | 100 | 100 | 100 |
| (R32/R1234yf/CO2 | | | | | | | | |
| with 21.5% wt R32 | | | | | | | | |
| and 3% CO2) | | | | | | | | |
| R454C | | | 4.2 | 14 | 90 | 100 | 90 | 100 |
| (R32/R1234yf with | | | | | | | | |
| 21.5% wt R32) | | | | | | | | |
| R32 | R1234yf | propane | | | | | | |
| 20 | 75 | 5 | 5.1 | 14 | 95 | 99 | 95 | 100 |
| 20 | 74 | 6 | 5.3 | 14 | 97 | 99 | 97 | 100 |
| 21 | 73 | 6 | 5.4 | 14 | 98 | 99 | 99 | 100 |
| 21.5 | 72.5 | 6 | 5.4 | 14 | 99 | 99 | 99 | 99 |
| 20 | 73 | 7 | 5.5 | 14 | 98 | 99 | 98 | 99 |
| 21 | 72 | 7 | 5.6 | 14 | 99 | 99 | 100 | 99 |
| 21.5 | 71.5 | 7 | 5.6 | 14 | 100 | 99 | 101 | 99 |
| 19 | 73 | 8 | 5.5 | 14 | 98 | 99 | 98 | 99 |
| 20 | 72 | 8 | 5.6 | 14 | 99 | 99 | 99 | 99 |
| 21 | 71 | 8 | 5.7 | 14 | 100 | 98 | 101 | 99 |
| 21.5 | 70.5 | 8 | 5.8 | 14 | 101 | 98 | 102 | 99 |
| 20 | 71 | 9 | 5.8 | 14 | 100 | 98 | 101 | 99 |
| 21 | 70 | 9 | 5.9 | 14 | 102 | 98 | 103 | 99 |
| 21.5 | 69.5 | 9 | 5.9 | 14 | 102 | 98 | 103 | 99 |

The results show that the compositions according to the invention advantageously have a CAP (volumetric capacity) greater than R454C.

In addition, the compositions according to the invention have a temperature at the outlet of the compressor less than that observed with R455A, which advantageously allows the reduction of mechanical stresses on the compressor, and increased installation performance. A high outlet temperature at the compressor requires cooling of the compressor, therefore loss of cooling energy. What is more, the compositions according to the invention are easier to prepare and to transfer than R455A because of the absence of CO₂ (because CO₂ is very volatile and soluble in oils).

1. A composition comprising from 69% to 78% by weight of 2,3,3,3-tetrafluoropropene, from 16% to 22% by weight of difluoromethane, and from 2% to 9% by weight of propane, relative to the total weight of the composition.

2. The composition according to claim 1, wherein the weight content of propane is between 3% and 9%.

3. The composition according to claim 1, wherein the weight content of 2,3,3,3-tetrafluoropropene is between 69% and 74%.

4. The composition according to claim 1, comprising from 69% to 78% by weight of 2,3,3,3-tetrafluoropropene, from 16% to 22% by weight of difluoromethane, and from 6% to 9% by weight of propane, relative to the total weight of the composition.

5. The composition according to claim 1, comprising from 69% to 74% by weight of 2,3,3,3-tetrafluoropropene, from 19% to 22% by weight of difluoromethane, and from 6% to 9% by weight of propane.

6. The composition according to claim 1, comprising from 70% to 72.5% by weight of 2,3,3,3-tetrafluoropropene, from 20% to 22.5% by weight of difluoromethane, and from 6.5% to 9% by weight of propane.

7. The composition according to claim 1, chosen from one of the following compositions:
69.7% by weight of 2,3,3,3-tetrafluoropropene, 21.4% by weight of difluoromethane, and 8.9% by weight of propane,
70.7% by weight of 2,3,3,3-tetrafluoropropene, 21.4% by weight of difluoromethane, and 7.9% by weight of propane,
71.7% by weight of 2,3,3,3-tetrafluoropropene, 21.4% by weight of difluoromethane, and 6.9% by weight of propane,
70% by weight of 2,3,3,3-tetrafluoropropene, 21% by weight of difluoromethane, and 9% by weight of propane,
69.5% by weight of 2,3,3,3-tetrafluoropropene, 21.5% by weight of difluoromethane, and 9% by weight of propane,
71% by weight of 2,3,3,3-tetrafluoropropene, 20% by weight of difluoromethane, and 9% by weight of propane,
70.5% by weight of 2,3,3,3-tetrafluoropropene, 21.5% by weight of difluoromethane, and 8% by weight of propane,
71% by weight of 2,3,3,3-tetrafluoropropene, 21% by weight of difluoromethane, and 8% by weight of propane,
72% by weight of 2,3,3,3-tetrafluoropropene, 20% by weight of difluoromethane, and 8% by weight of propane,
73% by weight of 2,3,3,3-tetrafluoropropene, 19% by weight of difluoromethane, and 8% by weight of propane,
71.5% by weight of 2,3,3,3-tetrafluoropropene, 21.5% by weight of difluoromethane, and 7% by weight of propane,
72% by weight of 2,3,3,3-tetrafluoropropene, 21% by weight of difluoromethane, and 7% by weight of propane,
73% by weight of 2,3,3,3-tetrafluoropropene, 20% by weight of difluoromethane, and 7% by weight of propane,
72.5% by weight of 2,3,3,3-tetrafluoropropene, 21.5% by weight of difluoromethane, and 6% by weight of propane,
73% by weight of 2,3,3,3-tetrafluoropropene, 21% by weight of difluoromethane, and 6% by weight of propane,
74% by weight of 2,3,3,3-tetrafluoropropene, 20% by weight of difluoromethane, and 6% by weight of propane,
75% by weight of 2,3,3,3-tetrafluoropropene, 20% by weight of difluoromethane, and 5% by weight of propane,
71.1% by weight of 2,3,3,3-tetrafluoropropene (±1.0%), 21% by weight of difluoromethane (+0.5%, −1.5%), and 7.9% by weight of propane (+0.1%, −0.9%).

8. The composition according to claim 1, wherein the composition has a GWP of less than 150.

9. The composition according to claim 1, wherein the composition has a lower inflammability limit greater than 100 g/m³.

10. A heat transfer fluid comprising the composition according to claim 1.

11. A method of replacing R455A or R454C, the method comprising replacing R455A or R454C with the composition according to claim 1.

12. A heat transfer composition comprising the composition according to claim 1, and at least one additive.

13. A heat transfer system comprising a composition according to claim 1, wherein the heat transfer system comprises a vapor compression circuit.

14. A heat transfer installation comprising a vapor compression circuit containing the composition according to claim 1, wherein the heat transfer installation is chosen from mobile or stationary installations heating by heat pumps, air conditioning, refrigeration, freezing and combustion engines.

15. A process for heating or cooling of a fluid or a substance using a vapor compression circuit containing a heat transfer fluid or a heat transfer composition, said process comprising successively the evaporation of the fluid or of the heat transfer composition, the compression of the fluid or of the heat transfer composition, the condensation of the fluid or of the heat transfer composition, and the relaxation of the fluid or of the heat transfer composition, wherein the heat transfer fluid is the composition according to claim 1.
